(19) United States
(12) Patent Application Publication
(10) Pub. No.: US 2020/0320918 A1
(43) Pub. Date: Oct. 8, 2020

(54) DISPLAY DEVICE HAVING REDUCED POWER CONSUMPTION

(71) Applicant: SILICON WORKS CO., LTD., Daejeon (KR)

(72) Inventors: Jung Min CHOI, Daejeon (KR); Jong Min PARK, Daejeon (KR); Hyun Mo YANG, Daejeon (KR); Young Gi KIM, Daejeon (KR)

(21) Appl. No.: 16/837,829

(22) Filed: Apr. 1, 2020

(30) Foreign Application Priority Data
Apr. 5, 2019 (KR) 10-2019-0040071
Mar. 4, 2020 (KR) 10-2020-0027101

(51) Int. Cl. G09G 3/20

(52) U.S. Cl. CPC G09G 3/20; G09G 2310/0291; G09G 2330/021

(57) ABSTRACT

Power consumption for display driving may be reduced by driving gate lines such that changes in pixel values are minimized

### CROSS REFERENCE TO RELATED APPLICATION

This application claims priority to Republic of Korea Patent Applications No. 10-2019-0040071 filed on Apr. 5, 2019 and Republic of Korea Patent Application No. 10-2020-0027101 filed on Mar. 4, 2020, each of which are hereby incorporated by reference in its entirety.

### BACKGROUND

### 1. Field of Technology

The present embodiment relates to a display driving technology for reducing the amount of consumed current through gate sorting.

### 2. Description of the Prior Art

A panel may have multiple gate lines disposed in one direction and may have multiple data lines disposed in a direction intersecting with the gate lines. In addition, pixel areas may be connected with the gate lines and the data lines. The data lines may be connected to pixels disposed in the pixel areas through switches, and the gate lines may control turning on/off of the switches, thereby controlling the connection between the data lines and the pixels.

A data driving device, which is also referred to as a source driver or a column driver, may produce a data voltage according to image data that indicates the brightness of the pixels, and may supply the produced data voltage to the data lines. If the data lines are connected to the pixels according to signals through the gate lines, the data voltage may be supplied to the pixels, the brightness of which may be adjusted according to the data voltage.

Meanwhile, when the data voltage is supplied, the amount of power consumed by the data driving device may be influenced by capacitive load components included in the data lines. Multiple parasitic capacitors are formed between the data lines and the neighboring electrodes, and such multiple parasitic capacitors may be recognized by the data driving device as capacitive load components.

The amount of power consumed by a capacitive load may be determined by the amount of change, per time, in the voltage supplied to the capacitive load. For example, if the amount of change in the voltage is large, the amount of power consumed by the capacitive load may have a large magnitude, and if the amount of change in the voltage is small, the amount of power consumed by the capacitive load may have a small magnitude.

The amount of change, per time, in the voltage related to the capacitive load also affects the amount of current. The amount of current increases in proportion to the amount of change in the voltage, and such an increase in the amount of current may increase the amount of power consumed by parasitic resistance existing in the data lines.

### SUMMARY

The present embodiment seeks to provide a technology for reducing the amount of change in the voltage occurring when a data voltage is applied in a data driving device, through efficient driving of gate lines, and accordingly reducing power consumption.

An aspect of the present embodiment is to provide a display driving technology for reducing the amount of consumed power.

Another aspect of the present embodiment is to provide a display driving technology for minimizing the amount of change in the data voltage.

Still another aspect of the present embodiment is to provide a display driving technology for adjusting the order of driving data lines, in order to minimize the amount of change in the data voltage.

In accordance with an embodiment, there is provided a data processing device including: a data processing controlling circuit to determine an order, in connection with multiple pixels connected with multiple gate lines and multiple data lines, for driving the multiple gate lines so as to minimize a change in a data voltage in one data line intersecting with the multiple gate lines; and a data processing signal transmitting circuit to transmit a gate selection signal indicating the order, wherein the data processing controlling circuit adds up pixel values of the multiple data lines with regard to each gate line to obtain total value, sets a reference gate line by comparing one total value with the others, and determines the order according to sizes of differences between the total value of the reference gate line and the total values of the other gate lines.

In connection with the data processing device, the data processing controlling circuit may determine a gate line having a maximum total value, that is, the largest one among the total values of the multiple gate lines, as the reference gate line.

In connection with the data processing device, the data processing controlling circuit may determine the order in which the total values are arranged in descending order with reference to the maximum total value.

In connection with the data processing device, the data processing controlling circuit may determine the order in which differences between the maximum total value and total values of the other gate lines are arranged in ascending order.

In connection with the data processing device, the data processing controlling circuit may determine a gate line having a minimum total value, that is, the smallest one among the total values of the multiple gate lines, as the reference gate line.

In connection with the data processing device, the data processing controlling circuit may determine the order in which the total values are arranged in ascending order with reference to the minimum total value.

In connection with the data processing device, the data processing controlling circuit may determine the order in which differences between the minimum total value and total values of the other gate lines are arranged in ascending order.

In connection with the data processing device, the data processing controlling circuit may determine the order such that a gate line having a higher proportion of red pixels is first driven if total value differences of total values of any certain two gate lines in relation to the reference gate line are within a predetermined range.

In connection with the data processing device, the pixel values may be all identical or partially different in one gate line intersecting with the multiple data lines.

In accordance with another embodiment, there is provided a gate driving device to drive multiple gate lines, the gate driving device including: a gate driving signal transmitting circuit to transmit a gate driving signal to the multiple gate lines; and a gate driving controlling circuit to select one after another of the multiple gate lines according to an order and to control the gate driving signal transmitting circuit to supply the gate driving signal to a selected gate line, wherein the gate driving controlling circuit first selects a reference gate line by comparing total values, each obtained by adding up pixel values of the multiple data lines for each gate line; and subsequently select other gate lines according to sizes of differences between the total value of the reference gate line and the total values of other gate lines.

In connection with the gate driving device, the reference gate line may have a maximum total value, that is, the largest one among the total values of the multiple gate lines.

In connection with the gate driving device, the gate driving controlling circuit may select gate lines respectively having total values smaller than the maximum total value in descending order of total values, or may select gate lines respectively having the differences in ascending order of the differences.

In connection with the gate driving device, the reference gate line may have a minimum total value, that is, the smallest among the total values of the multiple gate lines.

In connection with the gate driving device, the gate driving controlling circuit may select gate lines respectively having total values larger than the minimum total value in ascending order of total values, or may select gate lines respectively having the differences in ascending order of the differences.

As described above, according to the present embodiment, the amount of power consumed during display driving can be reduced, and the amount of change in the data voltage supplied to data lines can be minimized

### BRIEF DESCRIPTION OF THE DRAWINGS

The above and other aspects, features and advantages of the present disclosure will be more apparent from the following detailed description taken in conjunction with the accompanying drawings, in which:

FIG. 1 illustrates the configuration of a display device according to an embodiment;

FIG. 2 illustrates lines disposed on a display panel according to an embodiment;

FIG. 3 illustrates a first exemplary configuration of a display device according to an embodiment;

FIG. 4 illustrates a second exemplary configuration of a display device according to an embodiment;

FIG. 5 illustrates the configuration of a data processing device, a gate driving device, and a data driving device according to an embodiment;

FIG. 6 illustrates the configuration of a data driving device according to an embodiment;

FIG. 7 illustrates an exemplary gate line driving order according to the related art and power consumption resulting therefrom;

FIG. 8 illustrates an exemplary gate line driving order according to an embodiment, and power consumption resulting therefrom;

FIG. 9 illustrates another exemplary gate line driving order according to the related art and power consumption resulting therefrom;

FIG. 10 illustrates another exemplary gate line driving order according to an embodiment, and power consumption resulting therefrom;

FIG. 11 illustrates another exemplary gate line driving order according to the related art and power consumed in a charge sharing type;

FIG. 12 illustrates another exemplary gate line driving order according to the related art and power consumed in a floating type;

FIG. 13 illustrates another exemplary gate line driving order according to an embodiment in connection with FIG. 11 and FIG. 12;

FIG. 14 illustrates another example of power consumption according to an embodiment in connection with FIG. 13;

FIG. 15 illustrates another exemplary gate line driving order according to an embodiment in connection with FIG. 11 and FIG. 12;

FIG. 16 illustrates another example of power consumption according to an embodiment in connection with FIG. 15;

FIG. 17 illustrates another exemplary gate line driving order according to an embodiment in connection with FIG. 11 and FIG. 12;

FIG. 18 illustrates another example of power consumption according to an embodiment in connection with FIG. 17;

FIG. 19 illustrates another exemplary gate line driving order according to an embodiment in comparison with FIG. 11 and FIG. 12;

FIG. 20 illustrates another example of power consumption according to an embodiment in connection with FIG. 19;

FIG. 21 illustrates another exemplary gate line driving order according to an embodiment in comparison with FIG. 11 and FIG. 12; and

FIG. 22 illustrates another example of power consumption according to an embodiment in connection with FIG. 21.

### DETAILED DESCRIPTION

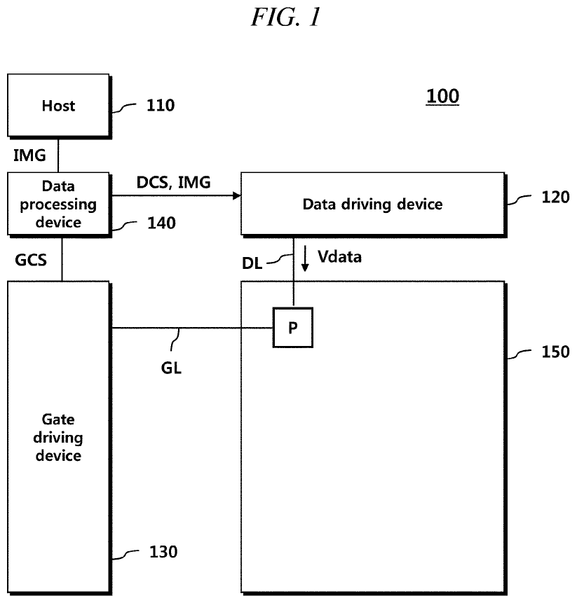

FIG. 1 illustrates the configuration of a display device according to an embodiment.

Referring to FIG. 1, the display device 100 may include multiple display driving devices 110, 120, 130, and 140 and a panel 150.

The panel 150 may have multiple data lines DL and multiple gate lines GL disposed thereon, and may have multiple pixels P disposed thereon and connected to the data lines DL and the gate lines GL.

The display driving devices 110, 120, 130, and 140 may refer to devices to produce signals for displaying images on the panel 150. A host 110, a data driving device 120, a gate driving device 130, and a data processing device 140 may correspond to the display driving devices 110, 120, 130, and 140.

The gate driving device 130 may supply a gate driving signal having a turn-on voltage or a turn-off voltage to the gate lines GL. If a gate driving signal having a turn-on voltage is supplied to the pixels P, the pixels P are connected to the data lines DL. In addition, if a gate driving signal having a turn-off voltage is supplied to the pixels P, the pixels P and the data lines DL are disconnected. The gate driving device 130 may be referred to as a gate driver.

The data driving device 120 may supply a data voltage Vdata to the pixels P through the data lines DL. The data voltage Vdata supplied to the data lines DL may be supplied to the pixels P according to a gate driving signal. The data driving device 120 may be referred to as a source driver.

The data processing device 140 may supply a control signal to the gate driving device 130 and the data driving device 120, and may transmit image data IMG to the data driving device 120. For example, the data processing device 140 may transmit a gate control signal GCS to the gate driving device 130 such that scanning begins. In addition, the data processing device 140 may transmit a data control signal DCS which controls the data driving device 120 to supply a data voltage Vdata to respective pixels P. The data processing device 140 may be referred to as a timing controller.

The host 110 may produce image data IMG and transmit the same to the data processing device 140. The host 110 may be referred to as a host.

Meanwhile, the gate driving device 130 may select gate lines GL according to a determined order and then transmit a data driving signal thereto. Conventional gate driving devices successively select gate lines from above to below and then transmit a gate driving signal thereto. The gate driving device 130 according to an embodiment may select gate lines GL according to a determined order and then transmit a gate driving signal thereto.

The data processing device 140 may determine a driving order regarding the gate lines GL, and may transmit a signal related to the order as a gate control signal GCS or as a separate signal. However, this is not limiting in any manner, and the order may be determined by the gate driving device 130 or the host 110.

The data processing device 140 may rearrange the brightness values regarding respective pixels according to the determined order, thereby producing image data IMG, and may transmit the image data IMG having the rearranged brightness values to the data driving device 120.

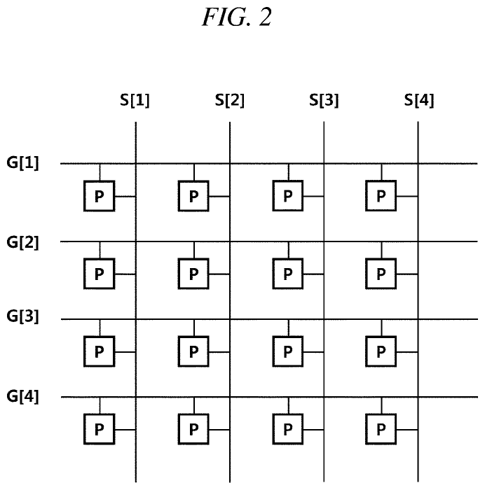

FIG. 2 illustrates lines disposed on a panel according to an embodiment.

Referring to FIG. 2, the panel may have gate lines G[1]-G[4] disposed in one direction, and may have data lines S[1]-S[4] disposed in a direction intersecting with that of the gate lines G[1]-G[4].

In addition, pixels areas may be defined by intersections between the gate lines G[1]-G[4] and the data lines S[1]-S[4], and pixels may be disposed in respective pixel areas. A pixel may be connected with one gate line and one data line intersecting with the one gate line.

Respective pixels may be connected to the data lines S[1]-S[4] through switches (not illustrated), and the switches (not illustrated) may be controlled by a gate driving signal supplied through the gate lines G[1]-G[4].

The panel to which an embodiment is applicable may be a liquid crystal display (LCD), an organic light-emitting diode (OLED) panel, a plastic OLED (POLED), a mini LED, a micro LED, or the like. An embodiment may be applied to a panel driven as a matrix of gate lines and data lines.

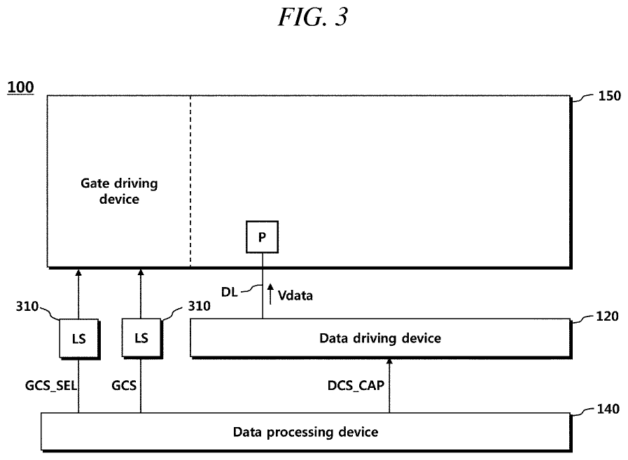

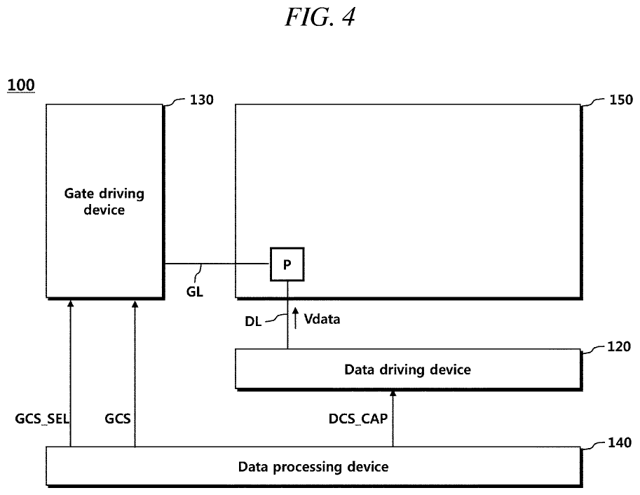

FIG. 3 illustrates a first exemplary configuration of a display device according to an embodiment, and FIG. 4 illustrates a second exemplary configuration of a display device according to an embodiment.

Referring to FIG. 3, the gate driving device 130 may be implemented as a gate on array (GOA) or a gate in panel (GIP). When the gate driving device 130 is implemented as a GOA or GIP, the gate driving device 130 may be formed integrally with a panel 150 and included in the panel 150, and may be a part of the panel 150.

Alternatively, referring to FIG. 4, the gate driving device 130 may be implemented as a gate integrated circuit (IC). When the gate driving device 130 is implemented in an IC type, the gate driving device 130 may be arranged outside the panel 150 and connected to the panel 150 by a gate line GL.

The data processing device 140 may be implemented as a timing controller T-Con. The data driving device 120 may be implemented as a source driver IC, a source readout IC (SRIC: source IC+readout IC (ROIC)), a T-Con embedded display (TED) IC, a touch display driving integration (TDDI) IC, or the like.

The display device 100 may output image data to multiple pixels connected with multiple gate lines and multiple data lines. The data processing device 140 may be included in the display device 100 as an inner circuit.

The data processing device 140 may determine the order for driving the multiple gate lines so as to minimize the change in the data voltage supplied to the data lines.

Specifically, the data processing device 140 may add up pixel brightness values of multiple data lines with regard to each gate line to obtain a total values; may set a reference gate line by comparing one total value with another; and may determine an order according to sizes of differences between the total value of the reference gate line and the total values of other gate lines. In this manner, the differences between the total values of the gate lines time-adjacently driven in such order may be minimized

In addition, the data processing device 140 may transmit a gate selection signal GCS_SEL, together with a gate control signal GCS, to the gate driving device 130. Information regarding the order of selecting gate lines may be included in the gate selection signal GCS_SEL, but is not limited thereto, and may be included in the gate control signal GCS and transmitted to the gate driving device 130. The gate selection signal GCS_SEL may be transmitted through one signal line or through multiple signal lines.

The data driving device 120 may receive image data arranged according to the order determined by the data processing device 140, and may output a data voltage corresponding to the arranged image data to the multiple pixels.

In addition, the data driving device 120 may include a buffer to output a data voltage corresponding to the image data by using a bias current. The buffer may output a data voltage by using a bias current corresponding to a change in the data voltage. The data processing device 140 may transmit a data driving capacity control signal DCS_CAP to the data driving device 120 in order to adjust the bias current so as to correspond to the change in the data voltage. By using the data driving capacity control signal DCS_CAP, the data driving device 120 may change the bias current supplied to the buffer so as to correspond to the changing data voltage.

Meanwhile, the display device 100 may further include a level shifter (LS) 310 (FIG. 3). The level shifter 310 may produce voltages appropriate for multiple devices, respectively, which require different voltage characteristics (for example, voltage magnitudes), and may deliver the same to the multiple devices. The level shifter 310 may receive a gate selection signal GCS_SEL from the data processing device 140, may change the characteristics thereof, and may transmit the same to the gate driving device 130. In addition, the level shifter 310 may receive a gate control signal GCS from the data processing device 140, may change the characteristics thereof, and may transmit the same to the gate driving device 130.

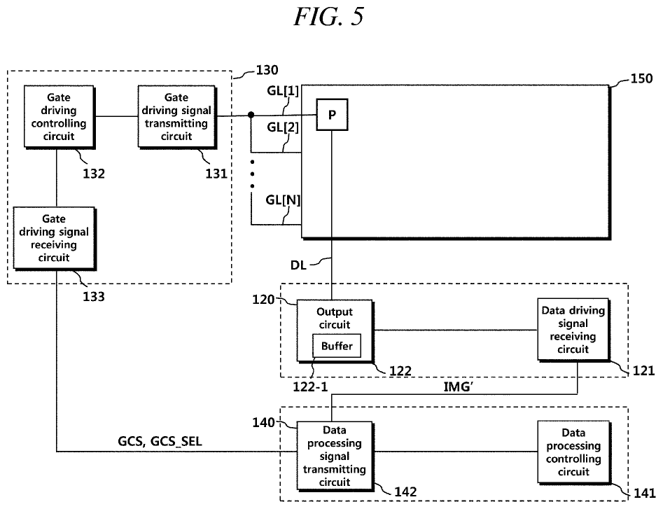

FIG. 5 illustrates the configuration of a data processing device, a gate driving device, and a data driving device according to an embodiment.

Referring to FIG. 5, the data processing device 140 may include a data processing controlling circuit 141 and a data processing signal transmitting circuit 142.

The data processing controlling circuit 141 may determine, in connection with multiple pixels connected with multiple gate lines and multiple data lines, the order for driving the multiple gate lines so as to minimize the change in the data voltage supplied to respective data lines. The data processing controlling circuit 141 may produce a gate selection signal indicating the order of driving the multiple gate lines.

In order to determine the above-mentioned order, the data processing controlling circuit 141 may add up pixel brightness values of the multiple data lines with regard to the multiple gate lines, thereby obtaining total values. The data processing controlling circuit 141 may set a reference gate line by comparing one total value with another.

As used herein, the total value may correspond to the total sum of data voltages applied to multiple data lines intersecting with one gate line. Alternatively, the total value may correspond to the total sum of brightness values or greyscale values of pixels formed at points of intersections between one gate line and multiple data lines. In addition, the reference gate line may be the first to be driven among the multiple gate lines. The reference gate line may be driven first, and other gate lines may be selected according to a predetermined order from the reference gate line and then driven.

In addition, the data processing controlling circuit 141 may determine the order of driving the multiple gate lines according to sizes of differences between the total value of the reference gate line and the total values of the other gate lines. In this manner, the differences between the total values of the gate lines time-adjacently driven in such order may be minimized

For example, the data processing controlling circuit 141 may set a gate line having the largest total value among the multiple gate lines (maximum total value) as the reference gate line. The data processing controlling circuit 141 may then arrange or sort the total values in descending order with reference to the maximum total value. That is, the data processing controlling circuit 141 may arrange or sort the gate lines such that the gate line having the largest total value comes first and the gate line having the smallest comes last.

Alternatively, the data processing controlling circuit 141 may arrange in ascending order differences between total values of other gate lines and the maximum total value. That is, the data processing controlling circuit 141 may arrange or sort the gate lines such that a gate line having the smallest difference of the total value comes first and a gate line having the largest one comes last.

In this manner, the multiple gate lines are not driven according to the order in which they are disposed (from the first line to the last line), but are selected in specific order and then driven.

As another example, the data processing controlling circuit 141 may configure a gate line having the smallest total value among the multiple gate lines (minimum total value) as the reference gate line. The data processing controlling circuit 141 may then arrange or sort the total values in descending order with reference to the minimum total value. That is, the data processing controlling circuit 141 may arrange or sort the gate lines such that the gate line having the smallest total value comes first, and the gate line having the largest one comes last.

Alternatively, the data processing controlling circuit 141 may arrange in ascending order differences of the total values of other gate lines with regard to the minimum total value. That is, the data processing controlling circuit 141 may arrange or sort the gate lines such that the gate line having the smallest difference of the total value comes first, and the gate line having the largest one comes last.

In this case as well, the multiple gate lines are not driven according to the order in which they are disposed (from the first line to the last line), but are selected in specific order and then driven.

In addition, the data processing controlling circuit 141 may determine the order such that a gate line having a high proportion of red pixels is first driven, when the differences of the total values with regard to the reference gate line are identical or within a predetermined range.

For reference, in the case of pixels disposed at points of intersections between one gate line and multiple data lines, the brightness values, greyscale values, or data voltages of the pixels in one gate line may be all identical or may be partially different.

For example, when four data lines intersect with one gate line, the pixel brightness values of the four may all be identical (255,255,255,255) or may be partially different (255,63,255,127).

The data processing device 140 may add information regarding the order of driving gate lines to a gate control signal GCS or to a gate selection signal GCS_SEL independent thereof.

The data processing signal transmitting circuit 142 may receive the gate selection signal GCS_SEL indicating the order described above from the data processing controlling circuit 141, and may transmit the same to the gate driving device 130.

In addition, the data processing controlling circuit 141 of the data processing device 140 may arrange image data according to the order for driving multiple gate lines, and may transmit the arranged image data IMG′ to the data driving device 120. The data processing signal transmitting circuit 142 may receive the arranged image data IMG′ from the data processing controlling circuit 141 and may transmit the same to the data driving signal receiving circuit 121 of the data driving device 120.

Meanwhile, the gate driving device 130 may include a gate driving signal transmitting circuit 131, a gate driving controlling circuit 132, and a gate driving signal receiving circuit 133.

The gate driving signal transmitting circuit 131 may transmit a gate driving signal to multiple gate lines. For example, the gate driving signal transmitting circuit 131 may receive a control command from the gate driving controlling circuit 132, and may supply a gate driving signal to first to N^{th} gate lines G[1]-G[N] according to a gate line driving order included in the control command. The gate driving signal transmitting circuit 131 may use a scheme of supplying the gate driving signal to each gate line at a different time according to the order. Alternatively, the gate driving signal transmitting circuit 131 may use a scheme of simultaneously supplying a gate driving signal including multiple waveforms having different timings to all gate lines.

The gate driving controlling circuit 132 may select one after another of the multiple gate lines according to the order and may control the gate driving signal transmitting circuit 131 to supply a gate driving signal to a selected gate line.

The gate driving controlling circuit 132 may first select a reference gate line by comparing total values of multiple gate lines. In addition, the gate driving controlling circuit 132 may subsequently select other gate lines according to sizes of differences between the total value of the reference gate line and the total values of other gate lines in ascending order. In this manner, the differences between the total values of the gate lines time-adjacently driven in ascending order may be minimized In this case, the gate driving signal transmitting circuit 131 may first supply a gate driving signal to the reference gate line and then supply gate driving signals to other gate lines in ascending order .by starting from a gate line having the minimum difference.

Considering the fact that the data processing device 140 determines the gate line driving order and delivers the same to the gate driving device 130, the order in which the gate driving device 130 drives gate lines may be identical to the order determined by the data processing device 140.

Accordingly, the reference gate line may be a gate line having the largest total value (maximum total value) among the total values of the multiple gate lines. The gate driving controlling circuit 132 may select gate lines having total values smaller than the maximum total value in descending order of the total values. The gate driving controlling circuit 132 may select gate lines having the above differences in ascending order of the differences. In addition, the reference gate line may be a gate line having a minimum total value, which is smallest among the total values of the multiple gate lines. The gate driving controlling circuit 132 may select gate lines having total values larger than the minimum total value in ascending order of total values. The gate driving controlling circuit 132 may select gate lines having the above differences in ascending order of differences.

Meanwhile, the data driving device 120 may include a data driving signal receiving circuit 121 and an output unit 122.

The data driving signal receiving circuit 121 may receive arranged image data IMG′ from the data processing signal transmitting circuit 142 of the data processing device 140.

The output circuit 122 may output a data voltage corresponding to the arranged image data IMG′ to pixels. The output circuit 122 may include a buffer 122-1 to output a data voltage by using a bias current. The buffer 122-1 may use a bias current corresponding to a changing data voltage, and the output unit 122 may further include a bias controlling circuit to supply a changing bias current. The bias controlling circuit may receive a data driving capacity control signal DCS_CAP and may output a bias current to the buffer 122-1 according to the data voltage of the arranged image data IMG′. The data driving capacity control signal DCS_CAP may include a command for controlling the intensity of the bias current corresponding to the arranged image data IMG′.

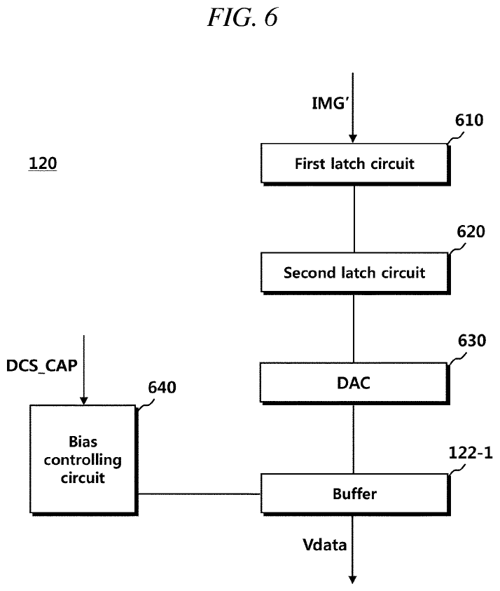

FIG. 6 illustrates the configuration of a data driving device according to an embodiment.

Referring to FIG. 6, the data driving device 120 may include a first latch circuit 610, a second latch circuit 620, a digital-to-analog converter (DAC) 630, a buffer 122-1, and a bias controlling circuit 640.

The first latch circuit 610 may latch image data The first latch circuit 610 may temporarily store image data and then output the same to the second latch circuit 620. The first latch circuit 610 may temporarily store image data and then output the same to the second latch circuit 620 according to a clock from a shift register (not illustrated). The image data may include arranged image data IMG′.

The second latch circuit 620 may latch image data. The second latch circuit 620 may temporarily store image data and then output the same to the DAC 630. The second latch circuit 620 may temporarily store image data and then output the same to the DAC 630 according to the clock from the shift register (not illustrated).

The DAC 630 may receive image data from the second latch circuit 620. The DAC 630 may convert the image data in an analog type, thereby producing an analog image signal. The DAC 630 may select a greyscale voltage corresponding to the image data transmitted from the second latch circuit 620, among greyscale voltages having predetermined steps produced from a gamma reference voltage output from the outside, and may output the same to the buffer 122-1. The analog image signal may refer to the selected greyscale voltage or a data voltage Vdata supplied to data lines.

The buffer 122-1 may receive the data voltage Vdata from the DAC 630. The buffer 122-1 may amplify the data voltage Vdata and may supply the same to data lines.

The buffer 122-1 may receive a bias current from the bias controlling circuit 640 and may output a data voltage Vdata. The bias controlling circuit 640 may receive a data driving capacity control signal DCS_CAP for adjusting the intensity of the bias current, by reflecting the arranged image data IMG′, and may accordingly supply a bias current having a different intensity to the buffer 122-1.

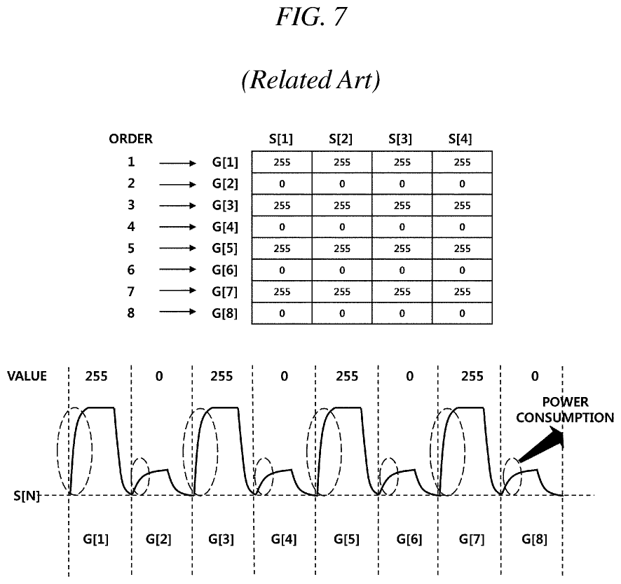

FIG. 7 illustrates an exemplary gate line driving order according to the related art and power consumption resulting therefrom.

Referring to FIG. 7, according to the conventional gate line driving order, the first to last lines are sequentially driven. Accordingly, power consumption occurs every time the data voltage changes between lines. In the diagram, the data voltage may be a positive voltage.

For example, referring to the top of FIG. 7, 32 pixels may be disposed at points of intersections between first to eighth gate lines G[1]-G[8] and first to fourth data lines S[1]-S[4]. Respective pixel values (for example, data voltages, brightness values, or greyscale values) may be (255,255,255,255) and (0,0,0,0) respectively repeating in every other line. It will be assumed in the following, for convenience of description, that the pixel values are brightness values. Then, the first to eighth gate lines G[1]-G[8] may sequentially be selected and driven (ORDER in FIG. 7).

Meanwhile, power consumption may occur every time the pixel values change in respective gate lines. Referring to the bottom of FIG. 7, the pixel value (VALUE FIG. 7) with regard to one data line (S[N] in FIG. 7) is illustrated. Due to the difference in pixel values between gate lines, power consumption may abruptly increase in the first gate line G[1], the third gate line G[3], the fifth gate line G[5], and the seventh gate line G[7], and may gently increase in the second gate line G[2], the fourth gate line G[4], the sixth gate line G[6], and the eighth gate line G[8] (POWER CONSUMPTION in FIG. 7). Since power consumption occurs at every point at which the pixel value changes, the total power consumption may correspond to the total sum of power consumption at each point.

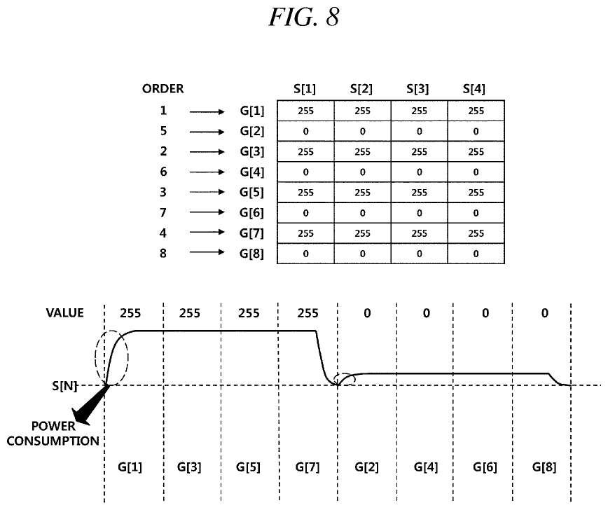

FIG. 8 illustrates an exemplary gate line driving order according to an embodiment in connection with FIG. 7, and power consumption resulting therefrom.

Referring to FIG. 8, according to the gate line driving order according to an embodiment, the first to last lines may be driven such that change in the data voltage is minimized It will be assumed in the following description that the order is determined by the data processing device, but the assumption is not limiting in any manner, and the order may be determined by a different display driving device (for example, the host, the gate driving device, or the data driving device). In the diagram, the data voltage may be a positive voltage.

According to the order, multiple gate lines, each having the highest pixel brightness value regarding one gate line and one data line or the highest total value of the pixel brightness values regarding one gate line and multiple data lines, may first be sequentially driven, and multiple gate lines, each having the second highest pixel brightness value or the second highest total value may subsequently be driven.

For example, referring to the top of FIG. 8, 32 pixels may be disposed at points of intersections between first to eighth gate lines G[1]-G[8] and first to fourth data lines S[1]-S[4]. Respective pixel values (for example, data voltages, brightness values, or greyscale values) may be (255,255,255,255) and (0,0,0,0) respectively repeating in every other line. Then, the first, third, fifth, and seventh gate lines G[1], G[3], G[5], and G[7] among the first to eighth gate lines G[1]-G[8] may be first selected and driven continuously, and the second, fourth, sixth, and eighth gate lines G[2], G[4], G[6], and G[8] may be next selected and driven continuously (ORDER in FIG. 8).

Meanwhile, power consumption may occur if the pixel value changes at some points. Referring to the bottom of FIG. 8, the pixel value (VALUE FIG. 8) with regard to one data line (S[N] in FIG. 8) is illustrated. Due to the difference in pixel values between gate lines, power consumption may partially occur in the first gate line G[1], and may partially occur in the second gate line G[2] (POWER CONSUMPTION in FIG. 8). Power consumption occurs at every point at which the pixel value changes, but occurs at fewer points than in the case of FIG. 7, meaning that less power may be consumed. This is because the gate lines are driven such that the change in the pixel value can be reduced, if possible. Accordingly, the total power consumption may correspond to the total sum of power consumption at each point, and may be less than in the case of FIG. 7.

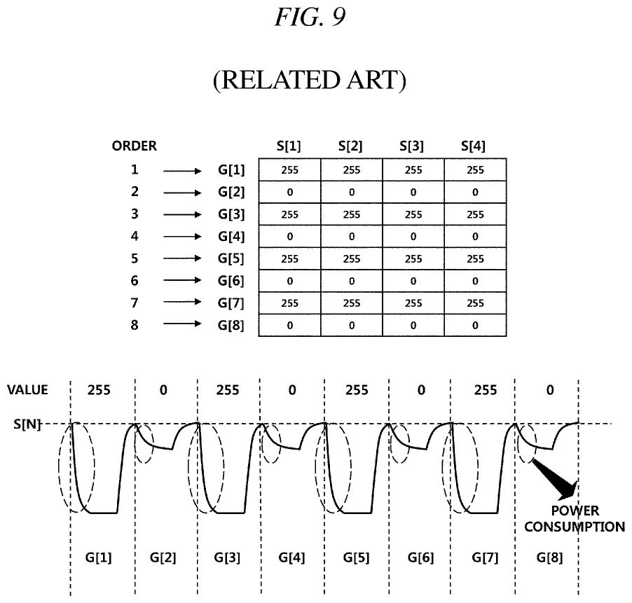

FIG. 9 illustrates another exemplary gate line driving order according to the related art and power consumption resulting therefrom.

Referring to FIG. 9, according to the conventional gate line driving order, the first to last lines are sequentially driven. Accordingly, power consumption occurs every time the data voltage changes between lines. In the diagram, the data voltage may be a negative voltage, unlike the cases illustrated in FIG. 7 and FIG. 8.

For example, referring to the top of FIG. 9, the first to eighth gate lines G[1]-G[8] may sequentially be selected and driven (ORFER in FIG. 9).

Meanwhile, power consumption may occur every time the pixel value changes in each gate line. Referring to the bottom of FIG. 9, the pixel value (VALUE FIG. 9) with regard to one data line (S[N] in FIG. 9) is illustrated. Due to the difference in pixel values between gate lines, power consumption may abruptly increase in the first gate line G[1], the third gate line G[3], the fifth gate line G[5], and the seventh gate line G[7], and may gently increase in the second gate line G[2], the fourth gate line G[4], the sixth gate line G[6], and the eighth gate line G[8] (POWER CONSUMPTION in FIG. 9). Since power consumption occurs at every point at which the pixel value changes, the total power consumption may correspond to the total sum of power consumption at each point.

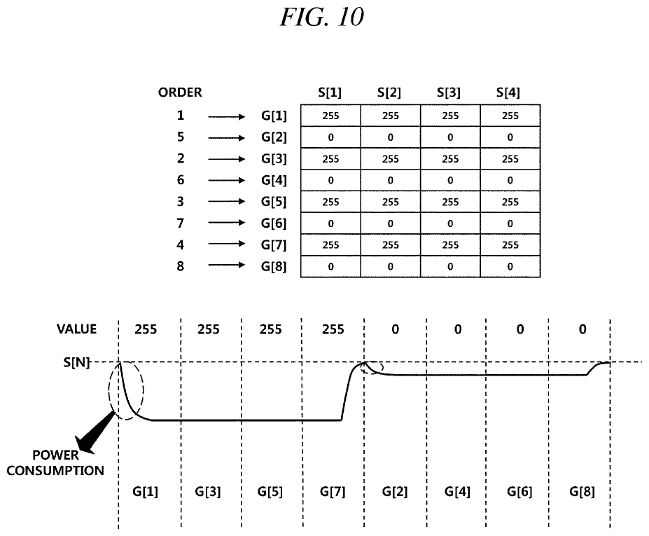

FIG. 10 illustrates another exemplary gate line driving order according to an embodiment in connection with FIG. 9, and power consumption resulting therefrom.

Referring to FIG. 10, according to the gate line driving order according to an embodiment, the first to last lines may be driven such that change in the data voltage is minimized It will be assumed in the following description that the order is determined by the data processing device, but the assumption is not limiting in any manner, and the order may be determined by a different display driving device (for example, the host, the gate driving device, or the data driving device). In the diagram, the data voltage may be a negative voltage, unlike the cases in FIG. 7 and FIG. 8.

According to the order, multiple gate lines, each having the highest pixel value regarding one gate line and one data line or the highest total value of the pixel values regarding one gate line and multiple data lines, may first be sequentially driven, and multiple gate lines, each having the second highest pixel value or the second highest total value may subsequently be driven.

For example, referring to the top of FIG. 10, the first, third, fifth, and seventh gate lines G[1], G[3], G[5], and G[7] among the first to eighth gate lines G[1]-G[8] may be first selected and driven continuously, and the second, fourth, sixth, and eighth gate lines G[2], G[4], G[6], and G[8] may be next selected and driven continuously (ORDER in FIG. 10).

Meanwhile, power consumption may occur if the pixel value changes at some points. Referring to the bottom of FIG. 10, the pixel value (VALUE FIG. 10) with regard to one data line (S[N] in FIG. 10) is illustrated. Due to the difference in pixel values between gate lines, power consumption may partially occur in the first gate line G[1], and may partially occur in the second gate line G[2] (POWER CONSUMPTION in FIG. 10). Power consumption occurs at every point at which the pixel value changes, but occurs at fewer points than in the case of FIG. 9, meaning that less power may be consumed. This is because the gate lines are driven such that the change in the pixel value can be reduced, if possible. Accordingly, the total power consumption may correspond to the total sum of power consumption at each point, and may be less than in the case of FIG. 9.

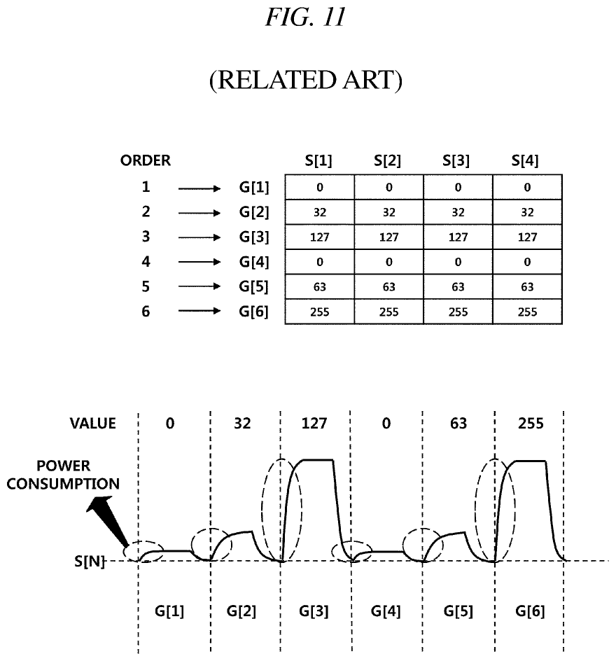

FIG. 11 illustrates another exemplary gate line driving order according to the related art and power consumed in a charge sharing type.

Referring to FIG. 11, according to the conventional gate line driving order, the first to last lines are sequentially driven. Accordingly, power consumption occurs every time the data voltage changes between lines. It will be assumed in the following, for convenience of description, that the data voltage is a positive voltage.

For example, referring to the top of FIG. 11, 24 pixels may be disposed at points of intersections between first to sixth gate lines G[1]-G[6] and first to fourth data lines S[1]-S[4]. Respective pixel values (for example, data voltages, brightness values, or greyscale values) may be (0,0,0,0), (32,32,32,32), (127,127,127,127), (0,0,0,0), (63,63,63,63), and (255,255,255,255) with regard to respective gate lines. In this example, the pixel values are identical in the same gate line, but may differ between different gate lines. It will be assumed in the following, for convenience of description, that the pixel values are brightness values. Then, the first to sixth gate lines G[1]-G[6] may sequentially be selected and driven (ORDER in FIG. 11).

Meanwhile, power consumption may occur every time the pixel value changes in each gate line. Referring to the bottom of FIG. 11, the pixel value (VALUE FIG. 11) with regard to one data line (S[N] in FIG. 11) is illustrated. Due to the difference in pixel values between data lines, the data voltage may abruptly change through the first to third gate lines G[1]-G[3], and may again change abruptly through the fourth to sixth gate lines G[4]-G[6]. The power consumption may undergo the same change as the data voltage through the first to third gate lines G[1]-G[3] and through the fourth to sixth gate lines G[4]-G[6] (POWER CONSUMPTION in FIG. 11). Since power consumption occurs at every point at which the pixel brightness value changes, the total power consumption may correspond to the total sum of power consumption at each point.

For reference, in this example, the data driving device may apply the data voltage through charge sharing. If the data driving device uses charge sharing, power consumption may change more than in the case of using floating.

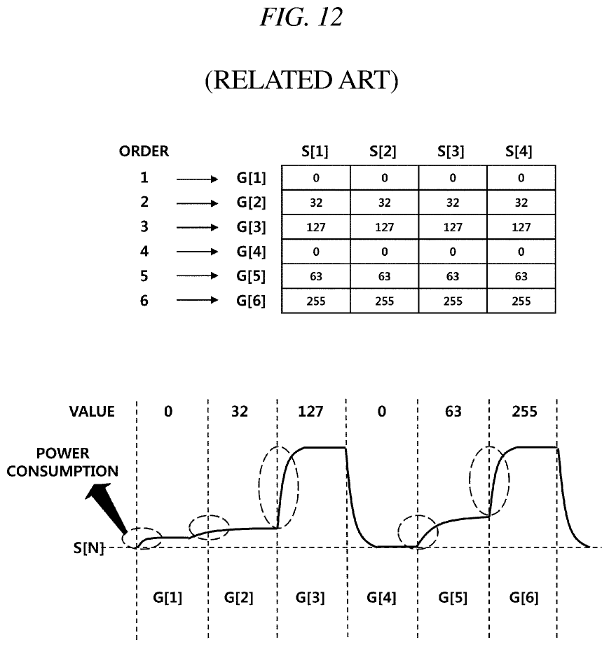

FIG. 12 illustrates another exemplary gate line driving order according to the related art and power consumed in a floating type.

Referring to FIG. 12, the data voltage in each data line and the aspect of power consumption resulting therefrom, when the data driving device applies the data voltage through floating, are illustrated.

As in the case of FIG. 11, the first to last lines are sequentially driven according to the gate driving order. The difference of FIG. 12 from FIG. 11 is in that the data voltage is applied in a floating type, instead of a charge sharing type.

If the data driving device uses floating, power consumption may change less than in the case of using charge sharing (POWER CONSUMPTION in FIG. 12).

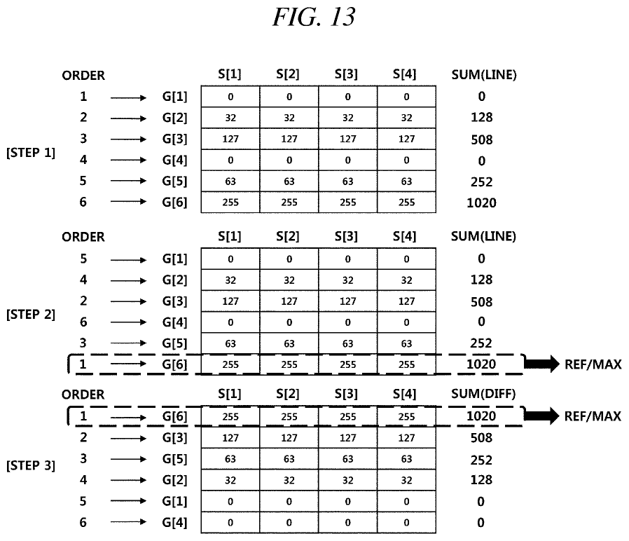

FIG. 13 illustrates another exemplary gate line driving order according to an embodiment in comparison with FIG. 11 and FIG. 12.

Referring to FIG. 13, the first to last lines in the gate line driving order according to an embodiment may be driven such that the change in the data voltage is minimized

In connection with the order, the data processing device may add up pixel values of the multiple data lines with regard to multiple gate lines, thereby obtaining total values; may set a reference gate line by comparing one total value with another; and may determine the order according to sizes of differences between the total value of the reference gate line and the total values of other gate lines. In this manner, the differences between the total values of the gate lines time-adjacently driven in ascending order may be minimized

The gate driving device may first select and drive the reference gate line by comparing the total values, and may then select and drive other gate lines in ascending order according to sizes of differences between the total value of the reference gate line and the total values of other gate lines. In this manner, the differences between the total values of the gate lines time-adjacently driven in ascending order may be minimized

The data processing device may obtain total values of multiple gate lines. For example, 24 pixels may be disposed at points of intersections between first to sixth gate lines G[1]-G[6] and first to fourth data lines S[1]-S[4]. Respective pixel values (for example, data voltages, brightness values, or greyscale values) may be (0,0,0,0), (32,32,32,32), (127,127,127,127), (0,0,0,0), (63,63,63,63), and (255,255,255,255) with regard to respective gate lines ([STEP 1] in FIG. 13). In this example, the pixel values are identical in the same gate line, but may differ between different gate lines. The data processing device may obtain (0,128,508,0,252,1010) as the total values of the first to sixth gate lines G[1]-G[6] (SUM(LINE) in FIG. 13).

The data processing device may select a gate line having the maximum total value, which is largest among the total values of the multiple gate lines, as the reference gate line. The reference gate line may be understood as the gate line selected first, or as a reference point for driving next selected gate lines. For example, the data processing device may select the sixth gate line G[6], which has a total value of 1020, as the reference gate line ([STEP 2] and

REF/MAX in FIG. 13).

The data processing device may arrange the total values in descending order, with reference to the maximum total value, thereby determining the order for driving the multiple gate lines. For example, the data processing device may arrange the total values (0,128,508,0,252,1020) corresponding to the first to sixth gate lines G[1]-G[6] in descending order from 1020, and may determine the gate line driving order on the basis thereof ([STEP 3] in FIG. 13). The total values arranged in descending order are 1020→508→252→128→0→0, and the order of driving the first to sixth gate lines G[1]-G[6] may be 6→3→5→2→1→4. Then, the gate driving device may sequentially select and drive the sixth gate line G[6], the third gate line G[3], the fifth gate line G[5], the second gate line G[2], the first gate line G[1], and the fourth gate line G[4]. In addition, the data driving device may apply data voltages corresponding to the pixel values of (255,255,255,255), (127,127,127,127), (63,63,63,63), (32,32,32,32), (0,0,0,0), and (0,0,0,0) to respective gate lines.

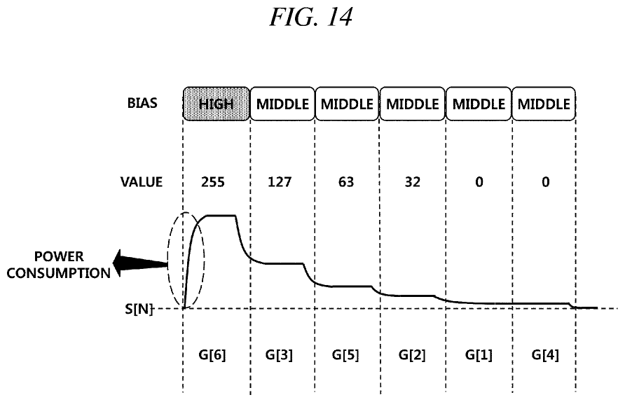

FIG. 14 illustrates another example of power consumption according to an embodiment in connection with FIG. 13.

Referring to FIG. 14, power consumption may occur at a point at which a data voltage regarding a reference gate line is applied.

For example, the data processing device may arrange total values in descending order with reference to the maximum total value, thereby determining the gate line driving order, and most power consumption may accordingly occur in the sixth gate line G[6] (POWER CONSUMPTION in FIG. 14). Since most power consumption occurs when a data voltage regarding a reference gate line is applied, the power consumption may be less than when driving gate lines in disposition order.

In addition, since gate lines are selected in descending order with reference to the maximum total value, the data voltage may gradually decrease from the first selected gate line to the last selected gate line. For example, the order of driving the first to sixth gate lines G[1]-G[6] in this diagram is 6→3→5→2→1→4, and the pixel values of a specific data line S[G] is 255→127→63→32→0→0, and the aspect of the data voltage may correspond thereto.

In addition, the bias current used by the data driving device to output the data voltage may follow the aspect of power consumption. For example, since the pixel values of the reference gate line change most, the largest bias current may be needed when applying the data voltage of the reference gate line (HIGH in FIG. 14). On the other hand, little power consumption occurs when applying a data voltage to other gate lines, and no bias current may accordingly be needed (MIDDLE in FIG. 14).

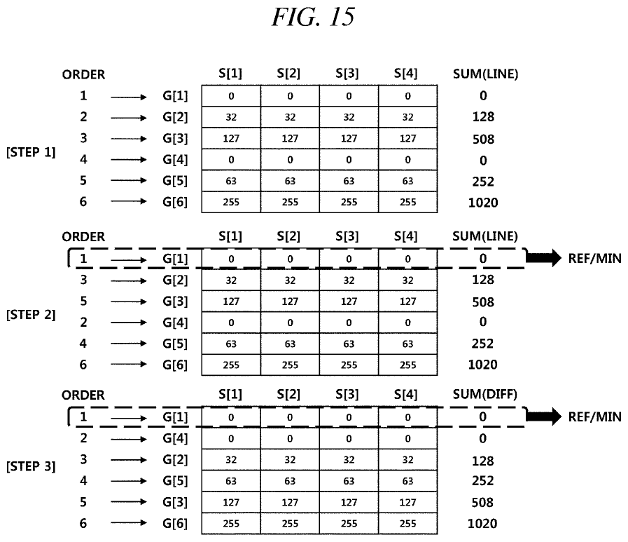

FIG. 15 illustrates another exemplary gate line driving order according to an embodiment in connection with FIG. 11 and FIG. 12.

Referring to FIG. 15, the first to last lines in the gate line driving order according to an embodiment may be driven such that the change in the data voltage is minimized To this end, the data processing device may arrange the gate lines in ascending order of total values with reference to the gate line having the minimum total value.

The data processing device may obtain total values of multiple gate lines. For example, the data processing device may obtain (0,128,508,0,252,1020), in the example in FIG. 13, as the total values of the first to sixth gate lines G[1]-G[6] ([STEP 1] and SUM(LINE) in FIG. 15).

The data processing device may select a gate line having the minimum total value, which is smallest among the total values of the multiple gate lines, as the reference gate line. For example, the data processing device may select the first gate line G[1], which has a total value of 0, as the reference gate line ([STEP 2] and REF/MIN in FIG. 15).

If two or more gate lines have the same total value, the data processing device may select one thereof as the reference gate line.

The data processing device may arrange the total values in ascending order, with reference to the minimum total value, thereby determining the order for driving the multiple gate lines. For example, the data processing device may arrange the total values (0,128,508,0,252,1020) corresponding to the first to sixth gate lines G[1]-G[6] in ascending order from 0, and may determine the gate line driving order on the basis thereof ([STEP 3] in FIG. 15). The total values arranged in ascending order are 0→0→128→252→508→1020, and the order of driving the first to sixth gate lines G[1]-G[6] may be 1→4→2→5→3→6. Then, the gate driving device may sequentially select and drive the first gate line G[1], the fourth gate line G[4], the second gate line G[2], the fifth gate line G[5], the third gate line G[3], and the sixth gate line G[6]. In addition, the data driving device may apply data voltages corresponding to the pixel brightness values of (0,0,0,0), (0,0,0,0), (32,32,32,32), (63,63,63,63), (127,127,127,127), and (255,255,255,255) to respective gate lines.

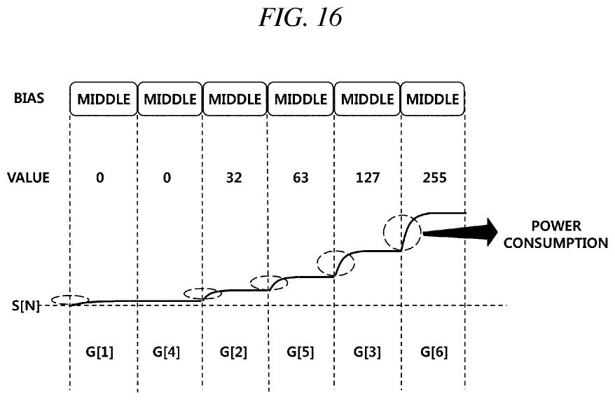

FIG. 16 illustrates another example of power consumption according to an embodiment in connection with FIG. 15.

Referring to FIG. 16, power consumption may occur at every point where a data voltage regarding a reference gate line is applied.

For example, the data processing device may arrange total values in ascending order with reference to the minimum total value, thereby determining the gate driving order, and power consumption may accordingly occur continuously through the first to sixth gate lines G[1]-G[6] (POWER CONSUMPTION in FIG. 16). Since power consumption partially occurs when data voltages are applied to the gate lines in order in which the gate lines are arranged, the power consumption may be less than when driving gate lines in disposition order.

In addition, since gate lines are selected in ascending order with reference to the minimum total value, the data voltage may gradually increase from the first selected gate line to the last selected gate line. For example, the order of driving the first to sixth gate lines G[1]-G[6] is 1→4→2→5→3→6 in this diagram, the pixel values of the first data line S[1] are accordingly 0→0→32→63→127→255, and the aspect of the data voltage may correspond thereto.

In addition, the bias current used by the data driving device to output the data voltage may follow the aspect of power consumption. For example, since the pixel values gradually increase with regard to selected gate lines, respectively, only a predetermined amount of bias current may be necessary each time the gate lines are changed (MIDDLE in FIG. 16).

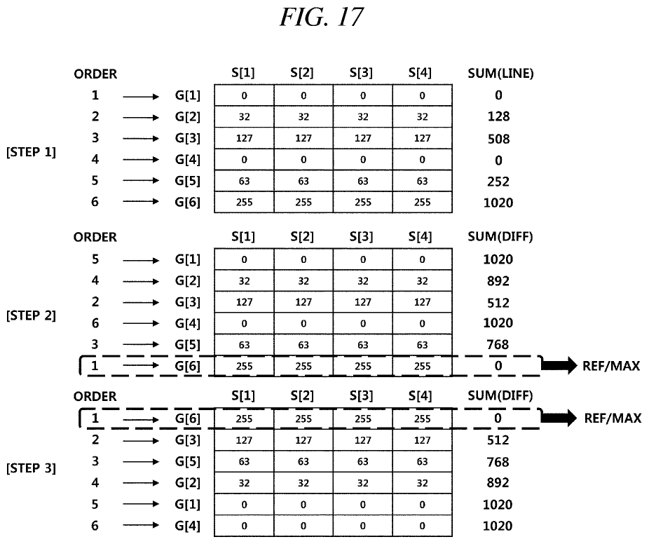

FIG. 17 illustrates another exemplary gate line driving order according to an embodiment in connection with FIG. 11 and FIG. 12.

Referring to FIG. 17, the first to last lines in the gate line driving order according to an embodiment may be driven such that the change in the data voltage is minimized

In connection with the order, the data processing device may add up pixel values of the multiple data lines with regard to each gate line, thereby obtaining a total value; may set a reference gate line by comparing one total value with another; and may determine the order according to sizes of differences between the total value of the reference gate line and the total values of other gate lines. In this manner, the differences between the total values of the gate lines time-adjacently driven in ascending order may be minimized

The gate driving device may first select and drive the reference gate line by comparing the total values, and may then select and drive other gate lines in ascending order according to sizes of differences between the total value of the reference gate line and the total values of other gate lines. In this manner, the differences between the total values of the gate lines time-adjacently driven in ascending order may be minimized

In this example, the data processing device may determine the order, according to the sizes of the differences between the total values of other gate lines and the total value of the reference gate line, to ascend.

The data processing device may obtain total values of multiple gate lines. For example, 24 pixels may be disposed at points of intersections between first to sixth gate lines G[1]-G[6] and first to fourth data lines S[1]-S[4]. Respective pixel values (for example, data voltages, brightness values, or greyscale values) may be (0,0,0,0), (32,32,32,32), (127,127,127,127), (0,0,0,0), (63,63,63,63), and (255,255,255,255) with regard to respective gate lines ([STEP 1] in FIG. 17). In this example, the pixel values are identical in the same gate line, but may differ between different gate lines. The data processing device may obtain (0,128,508,0,252,1020) as the total values of the first to sixth gate lines G[1]-G[6] (SUM(LINE) in FIG. 17).

The data processing device may select a gate line having the maximum total value, which is largest among the total values of the multiple gate lines, as the reference gate line. The reference gate line may be understood as the gate line selected first, or as a reference point for driving next selected gate lines. For example, the data processing device may select the sixth gate line G[6], which has a total value of 1020, as the reference gate line ([STEP 2] and REF/MAX in FIG. 17).

The data processing device may arrange the differences of the total values of other gate lines with regard to the total value of the reference gate line, which is the maximum, in ascending order, thereby determining the order for driving the multiple gate lines. For example, the data processing device may obtain (1020,892,512,1020,768,0) as differences of the total values of the first to sixth gate lines G[1]-G[6] with regard to the total value of the sixth gate line G[6] (SUM(DIFF) in FIG. 17). The differences may be obtained by subtracting the total values of the first to sixth gate lines G[1]-G[6] from the total value of the sixth gate line G[6]. The data processing device may arrange the differences of the total values in ascending order and determine the order of driving the multiple gate lines on the basis thereof ([STEP 3] in FIG. 17). Since the differences of total values arranged in ascending order are 0→512→768→892→1020→1020, the order of driving the first to sixth gate lines G[1]-G[6] may be 6→3→5→2→1→4. Then, the gate driving device may sequentially select and drive the sixth gate line G[6], the third gate line G[3], the fifth gate line G[5], the second gate line G[2], the first gate line G[1], and the fourth gate line G[4]. In addition, the data driving device may apply data voltages corresponding to the pixel values of (255,255,255,255), (127,127,127,127), (63,63,63,63), (32,32,32,32), (0,0,0,0), and (0,0,0,0) to respective gate lines.

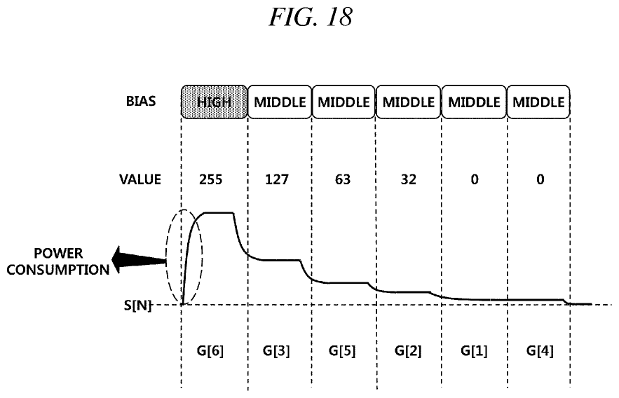

FIG. 18 illustrates another example of power consumption according to an embodiment in connection with FIG. 17.

Referring to FIG. 18, power consumption may occur at a point at which a data voltage regarding a reference gate line is applied.

For example, the data processing device may arrange differences of total values of other gate lines, with regard to the maximum total value, in ascending order, thereby determining the gate driving order, and most power consumption may accordingly occur in the sixth gate line G[6] (POWER CONSUMPTION in FIG. 18). Since most power consumption occurs when a data voltage regarding a reference gate line is applied, the power consumption may be less than when driving gate lines in disposition order.

In addition, since gate lines are selected with reference to the maximum total value, the data voltage may gradually decrease from the first selected gate line to the last selected gate line. For example, the order of driving the first to sixth gate lines G[1]-G[6] is 6→3→5→2→1→4 in this diagram, and the pixel values of the first data line S[1] are 255→127→63→32→0→0, and the aspect of the data voltage may correspond thereto.

In addition, the bias current used by the data driving device to output the data voltage may follow the aspect of power consumption. For example, since the pixel values of the reference gate line change most, the largest bias current may be needed when applying the data voltage of the reference gate line (HIGH in FIG. 18). On the other hand, little power consumption occurs when applying a data voltage to other gate lines, and no bias current or only a predetermined amount thereof may accordingly be needed (MIDDLE in FIG. 18).

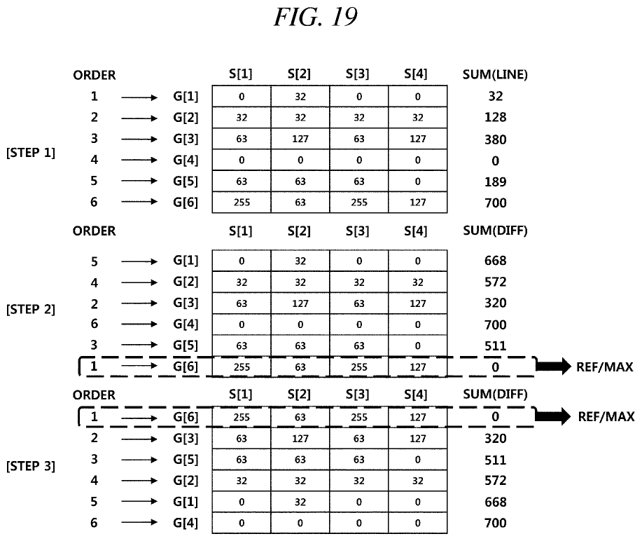

FIG. 19 illustrates another exemplary gate line driving order according to an embodiment in comparison with FIG. 11 and FIG. 12.

Referring to FIG. 19, the first to last lines in the gate line driving order according to an embodiment may be driven such that the change in the data voltage is minimized

In this example, the data processing device may arrange the differences of the total values of other gate lines, with regard to the total value of the reference gate line, in ascending order, thereby determining the order. In addition, pixel values in one gate line may differ, and pixels values in multiple gate lines may also differ.

The data processing device may obtain total values of multiple gate lines. For example, 24 pixels may be disposed at points of intersections between first to sixth gate lines G[1]-G[6] and first to fourth data lines S[1]-S[4]. Respective pixel values (for example, data voltages, brightness values, or greyscale values) may be (0,32,0,0), (32,32,32,32), (63,127,63,127), (0,0,0,0), (63,63,63,0), and (255,63,255,127) with regard to respective gate lines ([STEP 1] in FIG. 19). The data processing device may obtain (32,128,380,0,189,700) as the total values of the first to sixth gate lines G[1]-G[6] (SUM(LINE) in FIG. 19).

The data processing device may select a gate line having the maximum total value, which is largest among the total values of the multiple gate lines, as the reference gate line. The reference gate line may be understood as the gate line selected first, or as a reference point for driving next selected gate lines. For example, the data processing device may select the sixth gate line G[6], which has a total value of 700, as the reference gate line ([STEP 2] and REF/MAX in FIG. 19).

The data processing device may arrange the differences of total values of other gate lines, with reference to the total value of the reference gate line, in ascending order, thereby determining the order for driving the multiple gate lines. For example, the data processing device may obtain (668,572,320,700,511,0) as differences of the total values of the first to sixth gate lines G[1]-G[6] with regard to the total value of the sixth gate line G[6] (SUM(DIFF) in FIG. 19). The differences may be obtained by subtracting the total values of the first to sixth gate lines G[1]-G[6] from the total value of the sixth gate line G[6]. The data processing device may arrange the differences of the total values in ascending order and determine the order of driving the multiple gate lines on the basis thereof ([STEP 3] in FIG. 19). Since the differences arranged in ascending order are 0→320→511→572→668→700, the order of driving the first to sixth gate lines G[1]-G[6] may accordingly be 6→3→5→2→1→4. Then, the gate driving device may sequentially select and drive the sixth gate line G[6], the third gate line G[3], the fifth gate line G[5], the second gate line G[2], the first gate line G[1], and the fourth gate line G[4]. In addition, the data driving device may apply data voltages corresponding to the pixel values of (255,63,255,127), (63,127,63,127), (63,63,63,0), (32,32,32,32), (0,32,0,0), and (0,0,0,0) to respective gate lines.

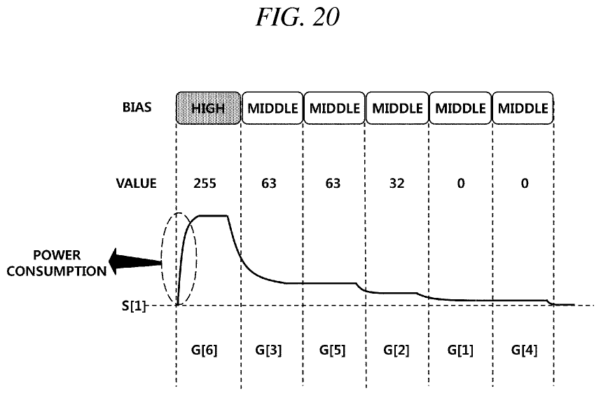

FIG. 20 illustrates another example of power consumption according to an embodiment in connection with FIG. 19.

Referring to FIG. 20, power consumption may occur at a point at which a data voltage regarding a reference gate line is applied.

For example, the data processing device may arrange differences of total values of other gate lines with regard to the maximum total value in ascending order, thereby determining the gate driving order, and most power consumption may accordingly occur in the sixth gate line G[6] (POWER CONSUMPTION in FIG. 20). Since most power consumption occurs when a data voltage regarding a reference gate line is applied, the power consumption may be less than when driving gate lines in disposition order.

In addition, since gate lines are selected with reference to the maximum total value, the data voltage may gradually decrease from the first selected gate line to the last selected gate line. For example, the order of driving the first to sixth gate lines G[1]-G[6] is 6→3→5→2→1→4 in this diagram, and the pixel values of the first data line S[1] are 255→63→63→32→0→0, and the aspect of the data voltage may correspond thereto.

In addition, the bias current used by the data driving device to output the data voltage may follow the aspect of power consumption. For example, since the pixel values of the reference gate line change most, the largest bias current may be needed when applying the data voltage of the reference gate line (HIGH in FIG. 20). On the other hand, little power consumption occurs when applying a data voltage to other gate lines, and no bias current or only a predetermined amount thereof may accordingly be needed (MIDDLE in FIG. 20).

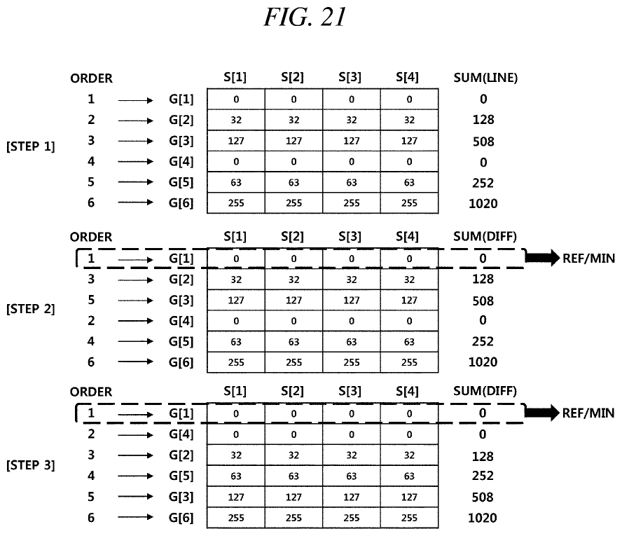

FIG. 21 illustrates another exemplary gate line driving order according to an embodiment in comparison with FIG. 11 and FIG. 12.

Referring to FIG. 21, the first to last lines in the gate line driving order according to an embodiment may be driven such that the change in the data voltage is minimized

In this example, the data processing device may arrange the differences of the total values of other gate lines, with regard to the total value of the reference gate line, in ascending order, thereby determining the order. In addition, the data processing device may determine a gate line having the smallest total value as the reference gate line.

The data processing device may obtain total values of multiple gate lines. For example, 24 pixels may be disposed at points of intersections between first to sixth gate lines G[1]-G[6] and first to fourth data lines S[1]-S[4]. Respective pixel values (for example, data voltages, brightness values, or greyscale values) may be (0,0,0,0), (32,32,32,32), (127,127,127,127), (0,0,0,0), (63,63,63,63), and (255,255,255,255) with regard to respective gate lines ([STEP 1] in FIG. 21). In this example, pixel values in one gate line are identical, but pixels values in multiple gate lines may differ. The data processing device may obtain (0,128,508,0,252,1020) as the total values of the first to sixth gate lines G[1]-G[6] (SUM(LINE) in FIG. 21).

The data processing device may select a gate line having the minimum total value, which is smallest among the total values of the multiple gate lines, as the reference gate line. The reference gate line may be understood as the gate line selected first, or as a reference point for driving next selected gate lines. For example, the data processing device may select the first gate line G[1], which has a total value of 0, as the reference gate line ([STEP 2] and REF/MIN in FIG. 21).

If two or more gate lines are entitled to be the reference gate line, the data processing device may select one thereof as the reference gate line.

The data processing device may arrange the differences of total values of other gate lines, with reference to the total value of the reference gate line, in ascending order with reference to the minimum total value, thereby determining the order for driving the multiple gate lines. For example, the data processing device may obtain (0,128,508,0,252,1020) as differences of the total values of the first to sixth gate lines G[1]-G[6] with regard to the total value of the first gate line G[1] (SUM(DIFF) in FIG. 21). The differences may be obtained by taking the absolute values of the results of subtracting the total values of the first to sixth gate lines G[1]-G[6] from the total value of the first gate line G[1]. The data processing device may arrange the differences of the total values in ascending order and determine the order of driving the multiple gate lines on the basis thereof ([STEP 3] in FIG. 21). Since the differences arranged in ascending order are 0→0→128→252→508→1020, the order of driving the first to sixth gate lines G[1]-G[6] may accordingly be 1→4→2→5→3→6. Then, the gate driving device may sequentially select and drive the first gate line G[1], the fourth gate line G[4], the second gate line G[2], the fifth gate line G[5], the third gate line G[3], and the sixth gate line G[6]. In addition, the data driving device may apply data voltages corresponding to the pixel values of (0,0,0,0), (0,0,0,0), (32,32,32,32), (63,63,63,63), (127,127,127,127), and (255,255,255,255) to respective gate lines.

If the differences of total values of two gate lines with regard to the reference gate line are within a predetermined range, the gate line having a higher proportion of red pixels may be driven first. For example, the total value difference of the first gate line G[1] and the total value difference of the fourth gate line G[4] may be identical, and the first gate line G[1] having a higher proportion of red pixels may be driven first in this case.

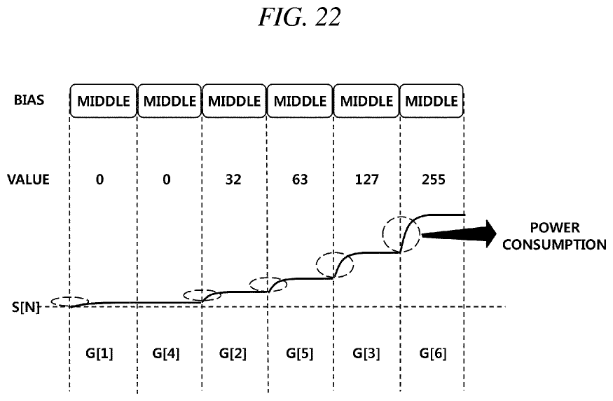

FIG. 22 illustrates another example of power consumption according to an embodiment in connection with FIG. 21.

Referring to FIG. 22, power consumption may occur at each point at which a data voltage regarding a reference gate line is applied.

For example, the data processing device may arrange differences of total values of other gate lines, with regard to the minimum total value, in ascending order, thereby determining the gate line driving order, and power consumption may accordingly occur continuously through the first to sixth gate lines G[1]-G[6] (POWER CONSUMPTION in FIG. 22). Since power consumption partially occurs when data voltages are applied in order in which the gate lines are arranged, the power consumption may be less than when driving gate lines in disposition order.

In addition, since gate lines are selected with reference to the minimum total value, the data voltage may gradually increase from the first selected gate line to the last selected gate line. For example, the order of driving the first to sixth gate lines G[1]-G[6] is 1→4→2→5→3→6 in this diagram, the pixel values of a specific data line S[N] are accordingly 0→0→32→63→127→255, and the aspect of the data voltage may correspond thereto.

In addition, the bias current used by the data driving device to output the data voltage may follow the aspect of power consumption. For example, since the pixel values gradually increase with regard to selected gate lines, respectively, only a predetermined amount of bias current may be necessary each time the gate lines are changed (MIDDLE in FIG. 22).

What is claimed is:

1. A data processing device comprising:
a data processing controlling circuit to determine an order, in connection with multiple pixels connected with multiple gate lines and multiple data lines, for driving the multiple gate lines such that a change in a data voltage in one data line intersecting with the multiple gate lines is minimized; and
a data processing signal transmitting circuit to transmit a gate selection signal indicating the order,
wherein the data processing controlling circuit adds up pixel values of the multiple data lines with regard to each gate line to obtain a total value, sets a reference gate line by comparing one total value with another total value, and determines the order according to sizes of differences between the one total value of the reference gate line and total values of other gate lines.

2. The data processing device of claim 1, wherein the data processing controlling circuit determines a gate line having a maximum total value, that is, a largest one among the total values of the multiple gate lines, as the reference gate line.

3. The data processing device of claim 2, wherein the data processing controlling circuit determines the order in which the total values are arranged in descending order with reference to the maximum total value.

4. The data processing device of claim 2, wherein the data processing controlling circuit determines the order in which differences between the maximum total value and the total values of the other gate lines are arranged in ascending order.

5. The data processing device of claim 1, wherein the data processing controlling circuit determines a gate line having a minimum total value, that is, a smallest one among the total values of the multiple gate lines, as the reference gate line.

6. The data processing device of claim 5, wherein the data processing controlling circuit determines the order in which the total values are arranged in ascending order with reference to the minimum total value.

7. The data processing device of claim 5, wherein the data processing controlling circuit determines the order in which differences between the minimum total value and the total values of the other gate lines are arranged in ascending order.

8. The data processing device of claim 1, wherein the data processing controlling circuit determines the order such that a gate line having a higher proportion of red pixels is first driven if differences of total values of any certain two gate lines in relation to the reference gate line are within a predetermined range.

9. The data processing device of claim 1, wherein the pixel values are all identical or partially different in one gate line intersecting with the multiple data lines.

10. A gate driving device to drive multiple gate lines, the gate driving device comprising:
a gate driving signal transmitting circuit to transmit a gate driving signal to the multiple gate lines; and
a gate driving controlling circuit to select one after another of the multiple gate lines according to an order and to control the gate driving signal transmitting circuit to supply the gate driving signal to a selected gate line,
wherein the gate driving controlling circuit first selects a reference gate line set by comparing total values, each total value obtained by adding up pixel values of multiple data lines for each gate line, and subsequently select other gate lines according to sizes of differences between the total value of the reference gate line and the total values of other gate lines.

11. The gate driving device of claim 10, wherein the reference gate line has a maximum total value, that is, a largest one among the total values of the multiple gate lines.

12. The gate driving device of claim 11, wherein the gate driving controlling circuit selects gate lines respectively having total values smaller than the maximum total value in descending order of the total values, or selects gate lines respectively having the differences in ascending order of the differences.

13. The gate driving device of claim 10, wherein the reference gate line has a minimum total value, that is, a smallest one among the total values of the multiple gate lines.

14. The gate driving device of claim 13, wherein the gate driving controlling circuit selects gate lines respectively having total values larger than the minimum total value in ascending order of the total values, or selects gate lines respectively having the differences in ascending order of the differences.
